(19) United States
(12) Patent Application Publication
(10) Pub. No.: US 2026/0233501 A1
(43) Pub. Date: Aug. 13, 2026

(54) Thermally-Sublimable Glitter Film Material

(71) Applicant: CHANCE LINE INDUSTRIAL CO., LTD., Siansi Township (TW)

(72) Inventors: Ming-Hsien YAO, Siansi Township (TW); Ling-Ching YAO, Siansi Township (TW); Chun-Hsien YAO, Siansi Township (TW); Shipeng WANG, Siansi Township (TW)

(21) Appl. No.: 19/533,737

(22) Filed: Feb. 9, 2026

(30) Foreign Application Priority Data
Feb. 10, 2025 (TW) 114104897

(51) Int. Cl. B32B 27/08; B32B 27/40; B32B 37/12

(52) U.S. Cl. CPC B32B 27/08; B32B 27/40; B32B 37/1207; B32B 2037/1215; B32B 2250/04; B32B 2264/0278; B32B 2264/1052; B32B 2264/107; B32B 2264/403; B32B 2307/306; B32B 2307/4026; B32B 2307/409; B32B 2307/748; B32B 2311/24; B32B 2315/02; B32B 2331/04; B32B 2367/00; B32B 2371/00; B32B 2375/00

(57) ABSTRACT

A thermally-sublimable glitter film material comprises: a base layer, an adhesive layer, a layered heat-resistant component, and a glitter layer are sequentially disposed on the base layer, the layered heat-resistant component is capable of withstanding high temperatures; the glitter layer is formed of glitter powders, each of the glitter powders has a pair of outer surfaces, the two outer surfaces are made of polyester material. Thereby, when a thermal-sublimation ink is thermally-sublimated onto the glitter layer of the glitter film material, the thermal-sublimation ink bonds with the polyester on the outer surfaces of the glitter powders, making the thermal-sublimation ink saturated and bright, providing patterns of the thermal-sublimation ink with a vivid and glossy color. The glitter film material is suitable for users to create thermal-sublimation patterns.

### FIELD OF THE INVENTION

The invention relates to a film material, specifically a glitter film material capable of thermally sublimating patterns, enabling users to easily create thermal-sublimation patterns on the glitter film material, and enabling a thermal-sublimation ink sublimated onto the glitter film material to have a vivid color.

### DESCRIPTION OF THE RELATED ART

Please refer to FIG. 19, which shows a glitter plotter-cut film 90 without patterns and a glitter plotter-cut film 100 with a pre-made pattern 108 that are currently sold on the market. Consumers can cut out graphics from the plotter-cut films 90 and 100 and stick the graphics on their clothes. Through glitter powders, the graphics have a shimmering effect.

As shown in FIG. 20, the glitter plotter-cut film 90 without patterns has a hot melt adhesive layer 92 and a glitter layer 94. The glitter layer 94 is formed from glitter powders. A molding process of the film 90 involves applying an adhesive to the hot melt adhesive layer 92, then sprinkling the glitter powders onto the adhesive, causing the glitter powders to adhere to the hot melt adhesive layer 92. A removable thin film 96 is attached to the glitter layer 94. A user cuts out a graphic from the glitter plotter-cut film 90, places the cut graphic on clothing, and applies heat to the graphic, causing the hot melt adhesive layer 92 to generate viscosity, thus adhering the graphic to the clothing.

The patterned glitter plotter-cut film 100, as shown in FIG. 21, also has a hot melt adhesive layer 102, a glitter layer 104, and a thin film 106 attached to and separable from the glitter layer 104. The glitter layer 104 is formed of glitter powders. A surface of the glitter layer 104 has the pattern 108 formed by a thermal-sublimation ink.

FIG. 22 illustrates a method of creating the pattern 108 on the glitter layer 104 of the plotter-cut film 100. Firstly, a semi-finished product of the plotter-cut film 100 is provided with the hot melt adhesive layer 102, the glitter layer 104, and a release paper 107. The hot melt adhesive layer 102 is attached to the release paper 107. The semi- finished product further has a thermal-sublimation paper 109 on which the pattern 108 is printed with a thermal-sublimation ink. The thermal-sublimation paper 109 is brought into contact with the glitter layer 104, and a high temperature of 180°C or higher is applied to the semi-finished product using a heat press or iron, causing the thermal-sublimation ink of the pattern 108 to thermally sublimate onto the glitter layer 104. After the pattern 108 has been thermally sublimated, the release paper 107 is separated from the hot melt adhesive layer 102, and then the separable thin film 106 is attached to the glitter layer 104, thus producing the glitter plotter-cut film 100 of FIG. 21.

The existing glitter plotter-cut films 90 and 100 have considerable inconvenience and drawbacks for both consumers and manufacturers. Firstly, existing glitter plotter-cut films do not enable consumers to create patterns, due to a fabrication process of the pattern 108. As mentioned earlier, the pattern 108 is sublimated from the thermal-sublimation paper 109 to the glitter layer 104. During heat pressing of the semi-finished product, the hot melt adhesive layer 102 melts. Therefore, the release paper 107 must be adhered to the hot melt adhesive layer 102 to maintain an integrity of the hot melt adhesive layer 102 and prevent the melted hot melt adhesive from sticking to other objects. After the pattern 108 has completed thermal-sublimation process, the release paper 107 is separated from the hot melt adhesive layer 102. When the patterned glitter plotter-cut film 100 is sold, it is not provided with the release paper 107.

However, after the pattern 108 is thermally-sublimated, the hot melt adhesive layer 102 adheres to the release paper 107, with a peel force as high as 200-300 grams per inch of width. This means it is difficult to separate the release paper 107 from the hot melt adhesive layer 102, making it suitable only for peeling off the release paper 107 in a factory and not for consumers to do themselves. That is especially true for small, pre-cut graphics, consumers find it extremely difficult to separate the release paper 107 from the hot melt adhesive layer 102. The high peel force between the hot melt adhesive layer 102 and the release paper 107 makes peeling off the release paper 107 difficult, often resulting in damage to the plotter-cut film 100 and the pattern 108, even in the factory. Due to the difficulty, thermal-sublimation of the pattern 108 of the existing patterned glitter plotter-cut film 100 and peeling of the release paper 107 are processed at the factory, without requiring consumers to create graphics and peeling the release paper 107 themselves.

Furthermore, when the pattern 108 is thermally-sublimated onto the plotter-cut film 100, the adhesive of the hot melt adhesive layer 102 penetrates the glitter layer 104 and adheres to the thermal-sublimation paper 109, causing the thermal-sublimation paper 109 to stick to the plotter-cut film 100. That is one of the reasons why it is not suitable for consumers to create thermal-sublimation patterns on existing glitter plotter-cut films themselves.

Therefore, commercially available glitter plotter-cut films are divided into two categories: patterned and unpatterned. The patterned glitter plotter-cut film 100 has the pattern 108 pre-made at a manufacturing end (FIG. 19 shows only one pattern). The glitter plotter-cut film 100 purchased by consumers already has the pattern 108. However, only a small portion of consumers want the pre-made pattern 108. In order to increase market share, manufacturers produce numerous styles of the plotter-cut film 100 with different patterns. Therefore, consumers are forced to choose from the glitter plotter-cut film 100 provided with a large variety of patterns that they can accept but do not truly like.

The unpatterned glitter plotter-cut film 90 is provided with the single-color glitter layer 94. In order to provide consumers with choices and purchasing opportunities, manufacturers produce a wide variety of different colors of the plotter-cut film 90 for consumers to choose from.

The existing problems with the glitter plotter-cut films 90 and 100 to be solved are as follows. On the consumer end, consumers cannot create patterns on the glitter plotter-cut films 90 and 100; if they want patterns, they can only accept glitter plotter-cut films with pre-printed patterns. On the manufacturing end, manufacturers must produce a variety of styles (patterns or colors) of the glitter plotter-cut films 90 and 100 for consumers to choose from, and they need large sales and display spaces, as well as large storage spaces. However, only two or three out of a hundred styles of plotter-cut films may be best-selling; the vast majority of styles of plotter-cut films cannot be sold and are difficult to recycle, and ultimately have to be destroyed, resulting in resource waste.

Existing glitter powders use aluminum to generate color. An aluminum layer is coated onto a polyester film, followed by applying color to change the polyester film's color. The polyester film is then cut into glitter powders to produce glitter powders with different colors. Alternatively, iridescent glitter powders can be made by cutting a coated film material, whose reflected or refracted light is an iridescent light.

When the thermal-sublimation ink on the thermal-sublimation paper is thermally-sublimated onto the silver glitter layer 104, a portion of the thermal-sublimation ink bonds to the aluminum in the glitter powders, while a portion bonds to polyester surfaces of the glitter powders. This results in unsaturated thermal-sublimation ink, loss of vividness, and a dull, lackluster color in the pattern 108 of the glitter plotter-cut film 100. Similarly, when the thermal-sublimation ink combines with iridescent glitter powders, the ink color is also dull and lackluster. Current technology cannot produce vivid thermally-sublimated patterns.

### SUMMARY OF THE INVENTION

One object of the invention is to provide a thermally-sublimable glitter film material capable of creating thermal-sublimation patterns on the glitter film material. The thermally-sublimable glitter film material is particularly suitable for users to create various thermal-sublimation patterns.

One object of the invention is to provide a thermally-sublimable glitter film material that enables a thermal-sublimation ink to sublimate with vivid colors on the glitter film material.

One object of the invention is to provide a thermally-sublimable glitter film material, the glitter film material has an adhesive layer and a base layer, and the invention is capable of achieving a low peel force between the adhesive layer and the base layer, making them easy to separate.

One object of the invention is to provide a thermally-sublimable glitter film material capable of preventing an adhesive layer of the film material from sticking to a thermal-sublimation paper and becoming difficult to separate during creation of thermal-sublimation patterns.

One object of the invention is to provide a thermally-sublimable glitter film material capable of reducing a variety of glitter film materials sold and displayed, thereby reducing inventory and manufacturing quantities, and being environmentally friendly.

The invention provides a thermally-sublimable glitter film material comprising:

a base layer with release properties;

an adhesive layer disposed on the base layer;

a layered heat-resistant component disposed on the adhesive layer, the layered heat-resistant component being capable of withstanding temperatures higher than those at which the adhesive layer generating viscosity when heated; and

a glitter layer comprising glitter powders, disposed on the heat-resistant component, the glitter powders of the glitter layer forming a glitter surface with tiny particles, the glitter surface being an outermost surface of the glitter film material, each of the glitter powders having a pair of outer surfaces positioned on opposite sides, the two outer surfaces being entirely made of polyester material.

Therefore, since the outer surfaces of the glitter powders are all made of polyester material, when a thermal-sublimation ink thermally sublimates to the glitter layer of the glitter film material, the thermal-sublimation ink bonds with the polyester on the outer surfaces of the glitter powders, causing the thermal-sublimation ink to develop color, possessing saturated and vivid color, and patterns of the thermal-sublimation ink have a vivid and glossy luster.

When the patterns are thermally-sublimated onto the glitter film material, the layered heat-resistant component is capable of blocking an adhesive of the adhesive layer, preventing the adhesive of the adhesive layer from passing through the layered heat-resistant component and reaching the glitter layer and making the glitter film material easily separate from a thermal-sublimation paper of the thermal-sublimation ink.

Preferably, the glitter powders are colored glitter powders, transparent iridescent glitter powders, or transparent glitter powders. The colored glitter powders are preferably silver or gold.

Preferably, each of the glitter powders is a sandwich structure having two outer layers and at least one inner layer, and the two outer layers are made of polyester material.

Preferably, the inner layer is colored, providing the glitter powders a color. Preferably, the inner layer has a metallic material, providing the glitter layer a metallic sheen, metallic luster. The inner layer has a material capable of producing an iridescent light, making the glitter layer an iridescent glitter layer, whose reflected or refracted light is an iridescent light (multicolored).

Preferably, the glitter powders are transparent glitter powders.

Preferably, the glitter layer comprises at least two of the transparent glitter powders, colored glitter powders and iridescent glitter powders.

Preferably, the glitter powders of the glitter layer comprise the transparent glitter powders and other glitter powders, the other powders are colored glitter powders or iridescent glitter powders, a proportion of the other glitter powders is less than a proportion of the transparent glitter powders.

Preferably, a peel force between the adhesive layer and the base layer is between 20 grams and 150 grams per inch of width, making the adhesive layer easy to peel from the base layer. More preferably, the peel force is between 20 grams and 100 grams per inch of width, or between 20 grams and 80 grams per inch of width.

Preferably, the adhesive layer is made of hot melt adhesive, after the adhesive layer generates viscosity when heated, a peel force between the adhesive layer and the base layer is between 20 grams and 150 grams per inch of width, making the adhesive layer easy to peel from the base layer. More preferably, the peel force is between 20 grams and 100 grams per inch of width, or between 20 grams and 80 grams per inch of width.

Preferably, the layered heat-resistant component is a high-temperature barrier layer capable of withstanding temperatures above 170°C. Preferably, the high-temperature barrier layer is made of high-temperature resistant thermoplastic polyurethane or polyurethane or polyester.

Preferably, the layered heat-resistant component is a layer of adhesive, and the layer of adhesive is capable of withstanding temperatures above 170°C.

Preferably, the layered heat-resistant component comprises a high-temperature barrier layer and a second layer, the high-temperature barrier layer is disposed on the adhesive layer, the second layer is disposed on the high-temperature barrier layer; the glitter layer is disposed on the second layer. Preferably, the second layer is a layer of adhesive.

Preferably, the high-temperature barrier layer is made of thermoplastic polyurethane layer; the second layer is made of polyurethane.

Preferably, the adhesive layer is made of EVA hot melt adhesive, PSA pressure-sensitive adhesive (self-adhesive), thermoplastic polyurethane (TPU) hot melt adhesive, and polyethersulfone (PES) hot melt adhesive. According to the inventor's actual tests, a peel force between the adhesive layer using these materials and the base layer is between 20 grams and 100 grams per inch of width, making it easy to peel off.

### BRIEF DESCRIPTION OF DRAWINGS

The objects, features, and achieved efficacies of the invention can be understood from the description and drawings of the following preferred embodiments, in which:

FIG. 1 is a cross-sectional view of a thermally-sublimable glitter film material according to a preferred embodiment of the invention.

FIGS. 2A to 2C show enlarged cross-sectional views of three types of glitter powders according to the invention, wherein the glitter powders in FIGS. 2A and 2B are made by cutting glitter material films in FIGS. 3A and 3B.

FIGS. 3A and 3B are cross-sectional views of two film-like glitter materials developed by the inventor of the invention.

FIG. 4 is a photograph of the thermally-sublimable glitter film material according to a preferred embodiment of the invention.

FIGS. 5 to 15 show a manufacturing process of forming a pattern printed with a thermal-sublimation ink onto a fabric using the glitter film material of the invention, wherein FIG. 9 shows a cross-sectional view of the thermal-sublimation ink thermally sublimating to a glitter layer of the glitter film material.

FIG. 16 shows a thermal-sublimation pattern formed on a fabric using the glitter film material of the invention.

FIGS. 17 and 18 show two thermal-sublimation patterns formed on fabrics using the glitter film material of the invention.

FIG. 19 shows two conventional glitter plotter-cut films.

FIG. 20 is a cross-sectional view of a conventional unpatterned glitter plotter-cut film.

FIG. 21 is a cross-sectional view of a conventional patterned glitter plotter-cut film.

FIG. 22 is a cross-sectional view of a semi-finished product of the patterned glitter plotter-cut film of FIG. 21, showing a method of manufacturing the patterned glitter plotter-cut film.

### DETAILED DESCRIPTION OF THE INVENTION

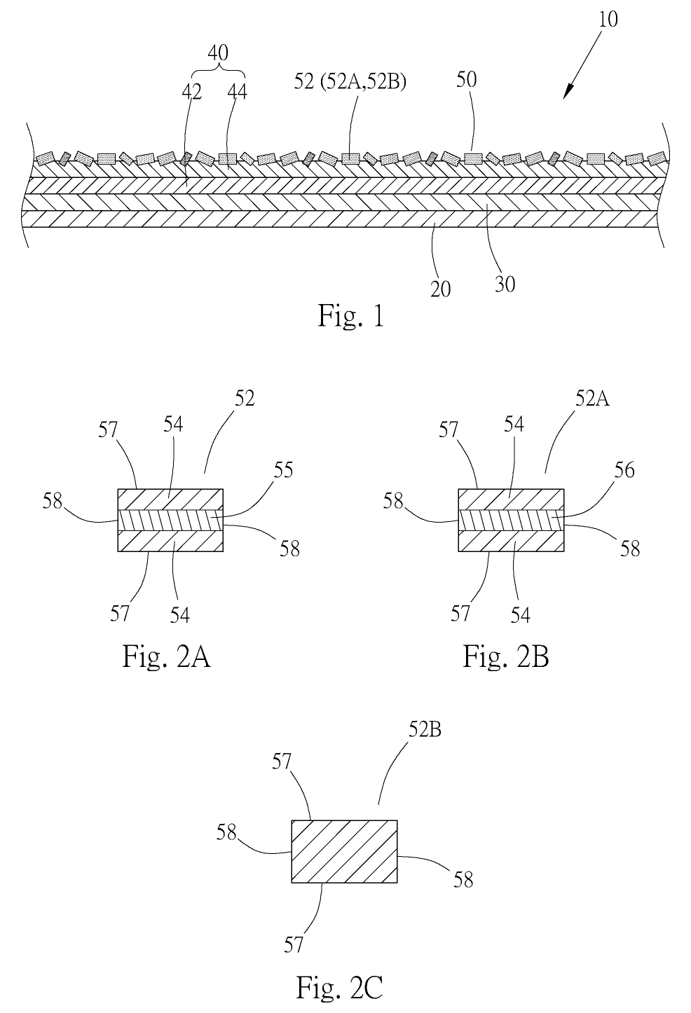

Please refer to FIG. 1, which illustrates a thermally-sublimable glitter film material 10 provided in a first preferred embodiment of the invention, comprising: a base layer 20, an adhesive layer 30, a layered heat-resistant component 40 and a glitter layer 50 stacked together. The glitter layer 50 is an outer layer of the glitter film material 10, serving as a glitter surface. Users can create thermal-sublimation patterns on the glitter layer 50 of the glitter film material 10.

The base layer 20 is a carrier with release properties, which can be a release film or a release paper.

The adhesive layer 30 is disposed on one surface of the base layer 20. In the invention, after the adhesive layer 30 is subjected to a high temperature and generates viscosity, a peel force between the adhesive layer 30 and the base layer 20 is between 20 grams and 150 grams per 1 inch of width, preferably between 20 grams and 100grams, and more preferably between 20 grams and 80 grams. Test conditions for the peel force are: the adhesive layer 30 and the base layer 20 are bonded together into a strip with a width of 1 inch, the adhesive layer 30 and the base layer 20 are pulled in opposite directions, and an acting force that can separate the adhesive layer 30 from the base layer 20 being the peel force. Therefore, after the glitter film material 10 is heat pressed, both adhesion force and peel force between the adhesive layer 30 and the base layer 20 are low, and the adhesive layer 30 and the base layer 20 can be easily separated. In this preferred embodiment, the adhesive layer 30 is a hot melt adhesive of the ethylene-vinyl acetate (EVA) copolymer series, which is solid at room temperature and melts into a viscous liquid adhesive (hot melt adhesive) when heated. The EVA hot melt adhesive layer 30 is polarized, making it easy to separate from the base layer 20 after the hot melt adhesive layer 30 generates viscosity. The adhesive layer 30 can use pressure-sensitive adhesive (PSA) (also known as self-adhesive), or polarized thermoplastic polyurethane (TPU) hot melt adhesive, or polarized polyethersulfone (PES) hot melt adhesive. According to the inventor's product and testing, a peel force between the adhesive layer 30 using these materials and the base layer 20 is between 20 grams and 150 grams per 1 inch of width. After the EVA hot melt adhesive layer 30 generates viscosity when heated, a peel force with the base layer 20 is 20~100 grams per 1 inch of width, making it easy to separate. After the PES hot melt adhesive generates viscosity when heated, a peel force with the base layer 20 is also 20~100 grams per 1 inch of width.

The layered heat-resistant component 40 is disposed on the adhesive layer 30 to isolate high temperatures and to isolate the adhesive layer 30, preventing an adhesive from the adhesive layer 30 from passing through the layered heat-resistant component 40 and spreading to the glitter layer 50. Preferably, the layered heat-resistant component 40 is capable of withstanding high temperatures above 180°C, more preferably, capable of withstanding high temperatures above 210°C, for example, 215~225°C.

In this preferred embodiment, the layered heat-resistant component 40 comprises: a high-temperature barrier layer 42 and a layer of adhesive 44, the lay of the adhesive 44 serves as a second layer of the heat-resistant component 40. The high-temperature barrier layer 42 is a layer of high-temperature resistant thermoplastic polyurethane (TPU) capable of withstanding the aforementioned high temperatures. The layer of adhesive 44 is a polyurethane (PU) adhesive. The high-temperature barrier layer 42 is disposed on one surface of the adhesive layer 30, and the layer of adhesive 44 is disposed on one surface of the high-temperature barrier layer 42 by coating or bonding. Once the layer of adhesive 44 is shaped, the layer of adhesive 44 will no longer react or generate viscosity when heated.

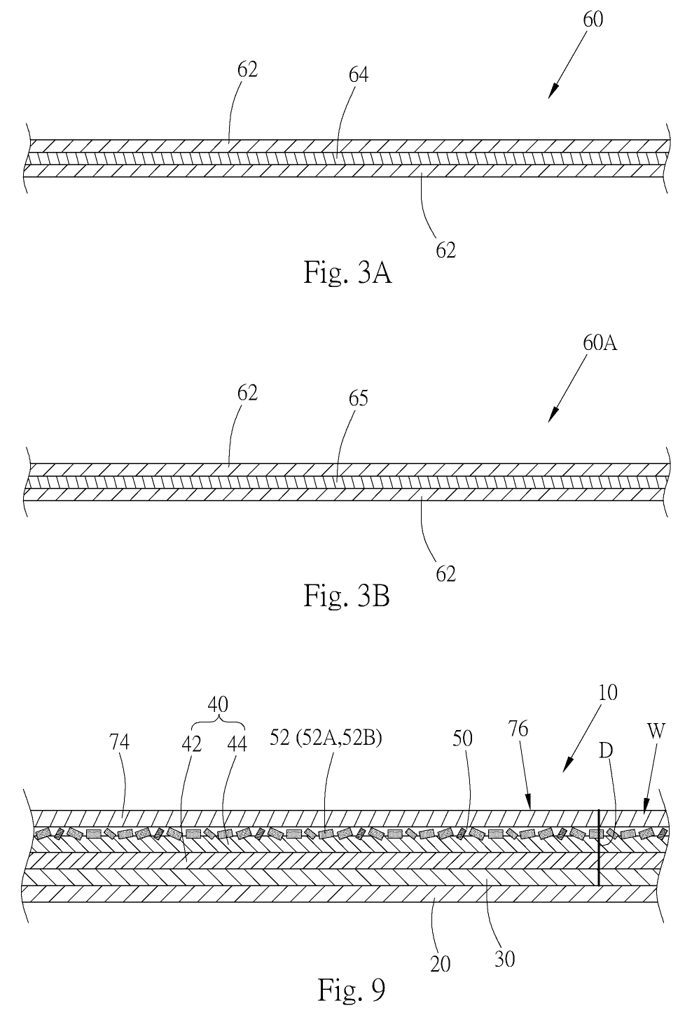

The glitter layer 50 is formed by a layer of glitter powders. Tiny, fine glitter powders are evenly sprinkled and adhered to the layer of adhesive 44 to form the glitter layer 50. For example, the layer of adhesive 44 is coated on the high-temperature barrier layer 42 in liquid form, and the glitter powders are sprinkled onto the layer of adhesive 44, then the excess glitter powders are cleaned off. FIGS. 2A to 2C show three types of glitter powders 52, 52A, and 52B of the invention, with a size of each of the glitter powders 52, 52A, or 52B, for example, but not limited to, 1/128 inch to 1/256 inch in this embodiment. The glitter powders 52 or 52A of the invention are fine particles made by cutting glitter material films 60, 60A shown in FIGS. 3A and 3B, and are formed in a square or hexagonal shape. The two glitter material films 60, 60A are invented by the inventor of the invention. The glitter material film 60 has two outer layers 62 and at least one inner layer 64. The two outer layers 62 are made of transparent polyester material, while the inner layer 64 comprises a metallic material, for example, the inner layer 64 is a layer of metallic material, such as an aluminum layer or a silver layer. The fine glitter powders 52 are made by cutting the glitter material film 60. Each of the glitter powders 52 forms a sandwich structure, having two transparent polyester outer layers 54 and an inner layer 55, the inner layer 55 is formed from the inner layer 64 of the glitter material film 60. For example, if the glitter powders 52 are silver glitter powders, the inner layer 55 thereof is plated with a layer of silver, while the two outer layers 54 are both polyester. The inner layer 55 makes the glitter powders 52 silver in color. By making the inner layer 55 in different colors, colored glitter powders of various colors can be produced.

The glitter material film 60A has the two outer layers 62 and at least one inner layer 65. The two outer layers 62 are made of transparent polyester, while the inner layer 65 is a polymer film capable of producing iridescence. For example, the polymer film has one coating or a plurality of coatings, causing a light refracted or reflected by the polymer film to be iridescent, achieving an iridescent visual effect. The inner layer 65 can also be a polymer film with zinc sulfide material capable of producing an iridescent visual effect. The fine glitter powders 52A are made by cutting the glitter material film 60A. Each of the glitter powders 52A is a sandwich structure, having the two transparent polyester outer layers 54 and an inner layer 56. The inner layer 56 is formed from the inner layer 65 of the glitter material film 60A, making the glitter powders 52A transparent iridescent glitter powders. Through the inner layer 56, a light refracted or reflected by the glitter powders 52A has an iridescent (multicolored) visual effect.

The glitter powders 52B shown in FIG. 2C are made by cutting a layer of transparent polyester material, resulting in transparent glitter powders.

Two outer surfaces 57 of the glitter powders 52, 52A, or 52B of the invention are all made of polyester, with no other materials other than polyester. Specifically, cross-sections of the glitter powders 52 or 52A are rectangular, with a pair of the outer surfaces 57 and a pair of cut surfaces 58 located on opposite sides. The two outer surfaces 57 are formed by the two outer layers 54, therefore, the two outer surfaces 57 are entirely made of polyester material, with no other materials present. Areas of the two cut surfaces 58 of the glitter powders 52 are mainly made of polyester material, with only small areas being a material of the inner layer 55. Similarly, the two cut surfaces 58 of the glitter powders 52A are mainly made of polyester material, with only a small area of each of the cut surfaces 58 being an area of the inner layer 56. The two outer surfaces 57 and the two cut surfaces 58 of the glitter powders 52B are entirely made of polyester material, with no other materials.

The glitter powders 52 make the glitter layer 50 a glitter surface with fine/tiny particles, the glitter surface is an outermost surface of the glitter film material 10. FIG. 4 is a photograph of a preferred embodiment of the glitter film material 10 of the invention, with an outermost surface being the glitter layer 50, densely covered with the glitter powders 52.

The following describes a process of using the glitter film material 10 of the invention in conjunction with a thermal-sublimation paper to thermally sublimate text or non-text patterns onto a fabric (e.g., clothing). The adhesive layer 30 of the glitter film material 10 is exemplified by EVA hot melt adhesive.

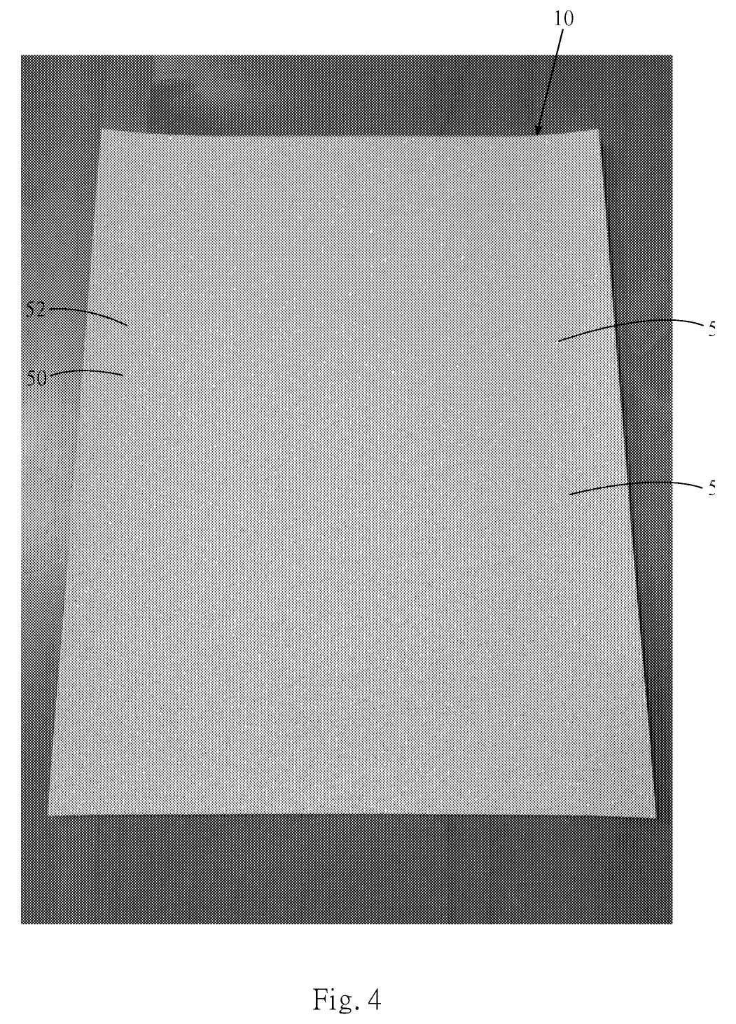

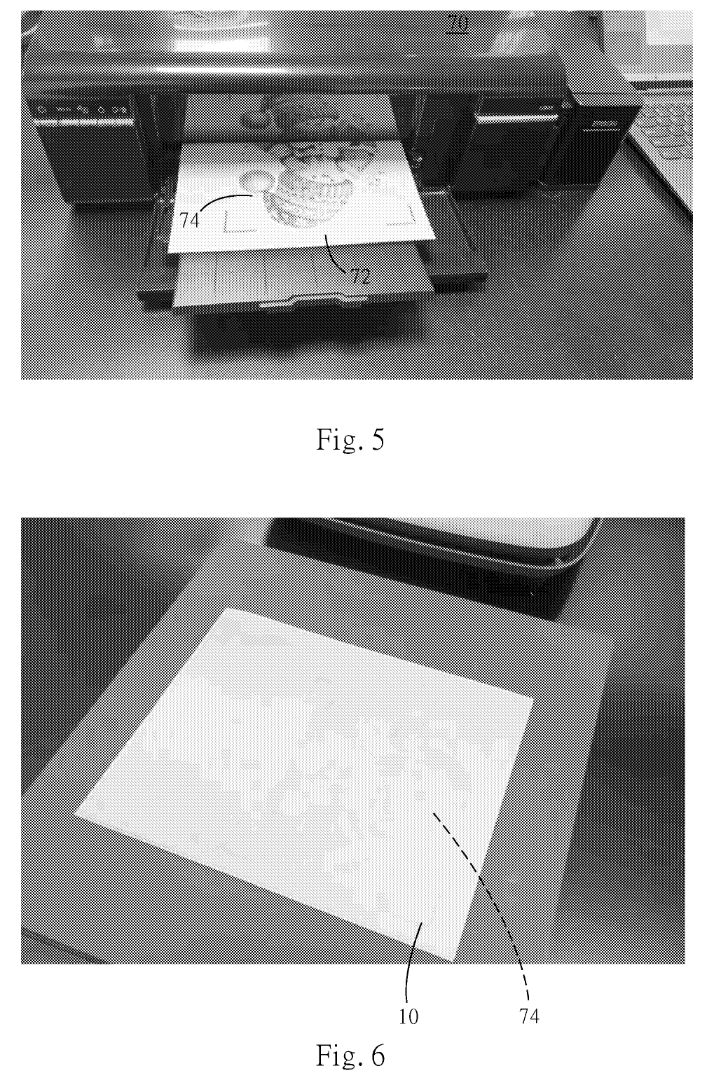

Please refer to FIG. 5, a user uses a household printer 70 to print a colored pattern 74 onto a thermal-sublimation paper 72 using a thermal-sublimation ink. The pattern 74 can be text (e.g., the English letters A, B, C) or non-text (e.g., people, landscapes, objects, symbols, etc.). The pattern 74 in FIG. 5 uses a snowman as an example.

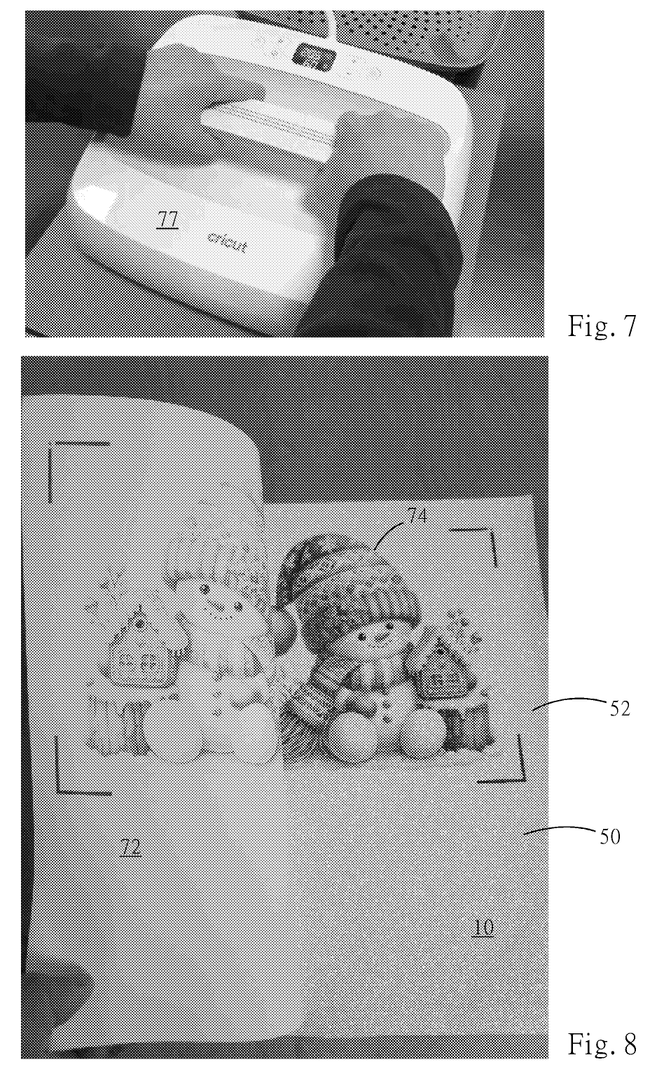

Please refer to FIG. 6, the glitter film material 10 of the invention is stacked with the thermal-sublimation paper 72 printed with the pattern 74, the pattern 74 is in contact with the glitter layer 50 of the glitter film material 10. Then, the glitter film material 10 and the thermal-sublimation paper 72 are heat-pressed using a heat press machine 77 or an iron, as shown in FIG. 7, for example, at a temperature of 205°C for 60 seconds.

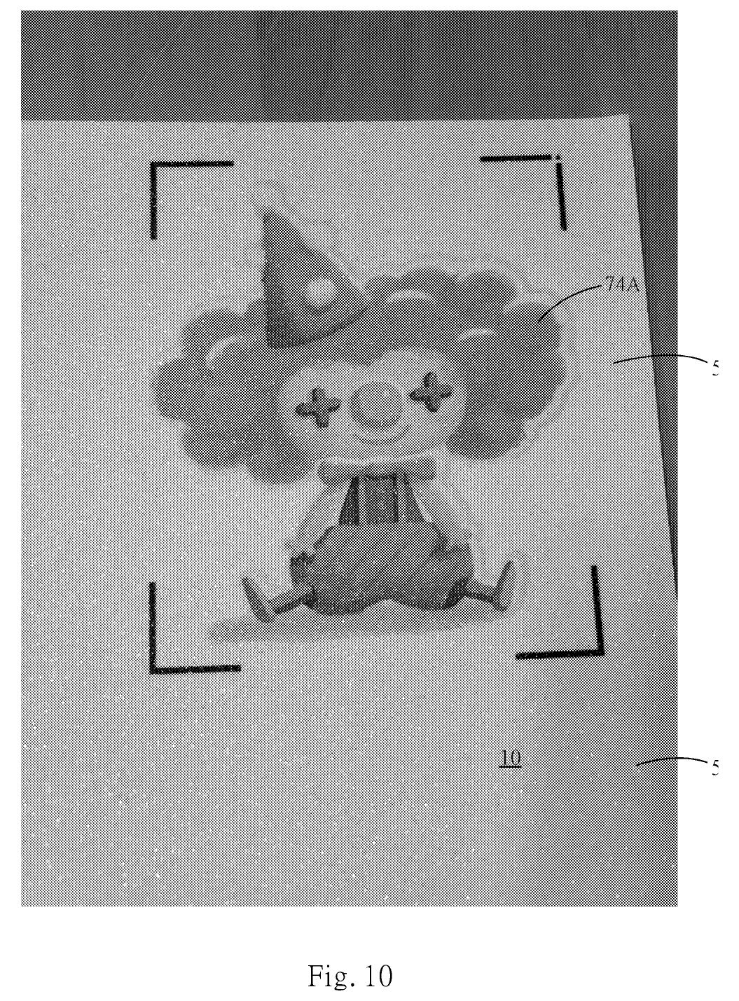

After heat pressing as shown in FIG. 7, the thermal-sublimation ink on the thermal-sublimation paper 72 is thermally-sublimated onto the glitter layer 50 of the glitter film material 10. As shown in FIG. 8, the thermal-sublimation paper 72 is separated from the glitter film material 10, revealing that the ink of the pattern 74 has been thermally-sublimated onto the glitter layer 50. Please refer to FIG. 9, the thermal-sublimation ink of the thermal-sublimation pattern 74 is bonded to the polyester surfaces (i.e., outer surfaces) 57 of the glitter powders 52. FIG. 10 shows another glitter film material 10 of the invention, the glitter film material 10 has another colored thermal-sublimation pattern 74A on the glitter layer 50.

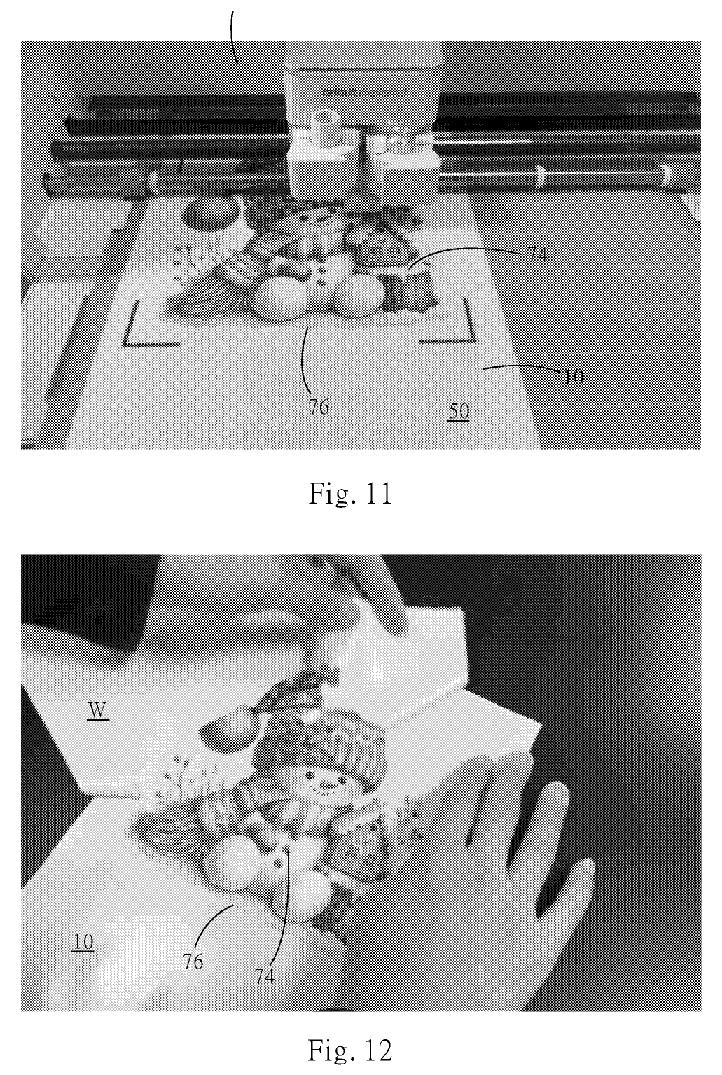

Afterwards, as shown in FIG. 11, a graphic 76 is cut from an outline of the pattern 74 using a household cutting machine 78. A cutting depth D of a cutter, as shown in FIG. 9, cuts through the glitter layer 50, the layer of adhesive 44, the high-temperature barrier layer 42, and the adhesive layer (hot melt adhesive layer) 30. After cutting, a waste material W other than the graphic 76 is removed, as shown in FIGS. 12 and 9, leaving only the graphic 76 on the glitter film material 10.

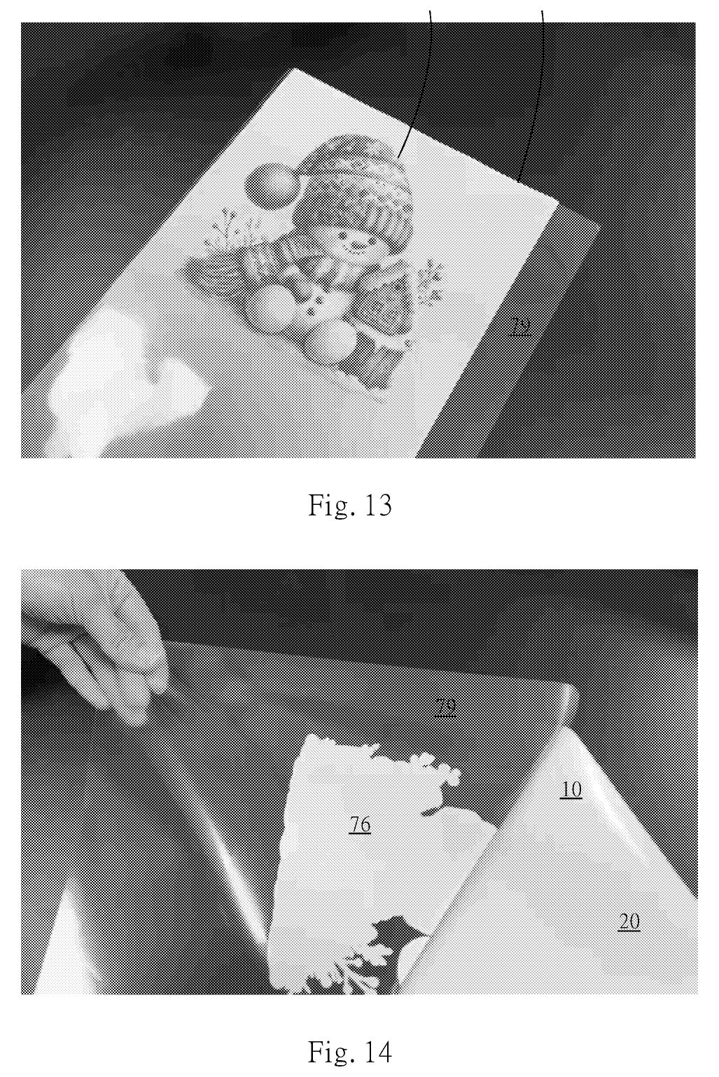

Then, as shown in FIG. 13, a transfer film 79 is adhered to the graphic 76, separating the graphic 76 from the base layer 20 of the glitter film material 10, as shown in FIG. 14. The graphic 76 separated from the base layer 20 has the thermal-sublimation pattern 74, the glitter layer 50, the heat-resistant component 40 and the adhesive layer 30.

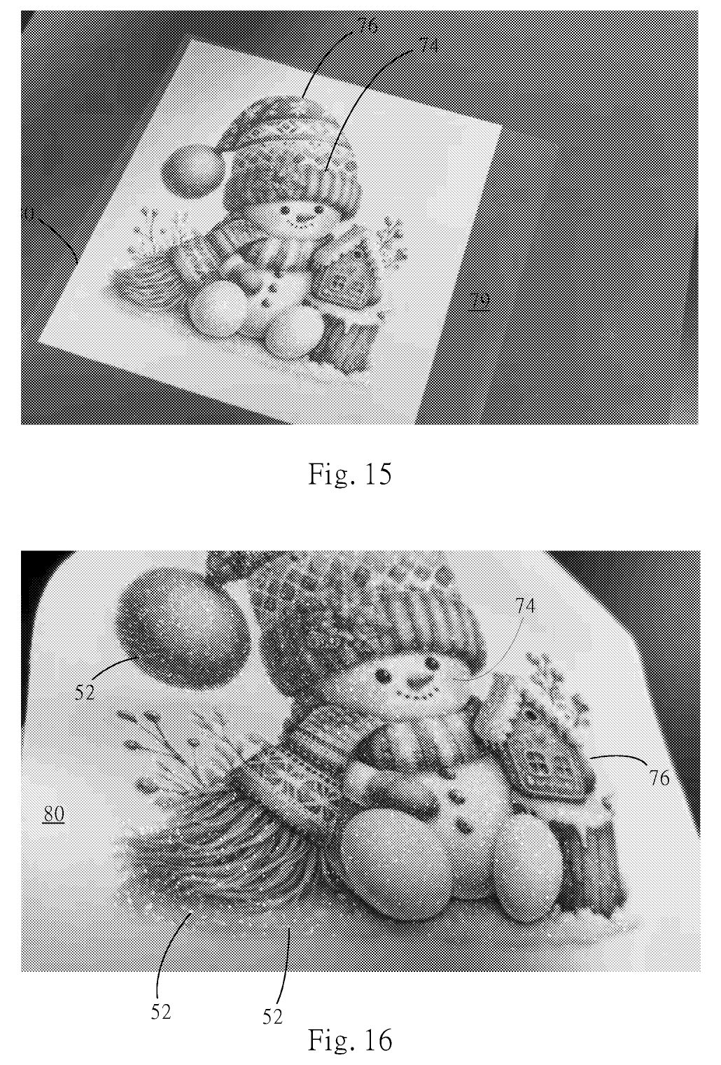

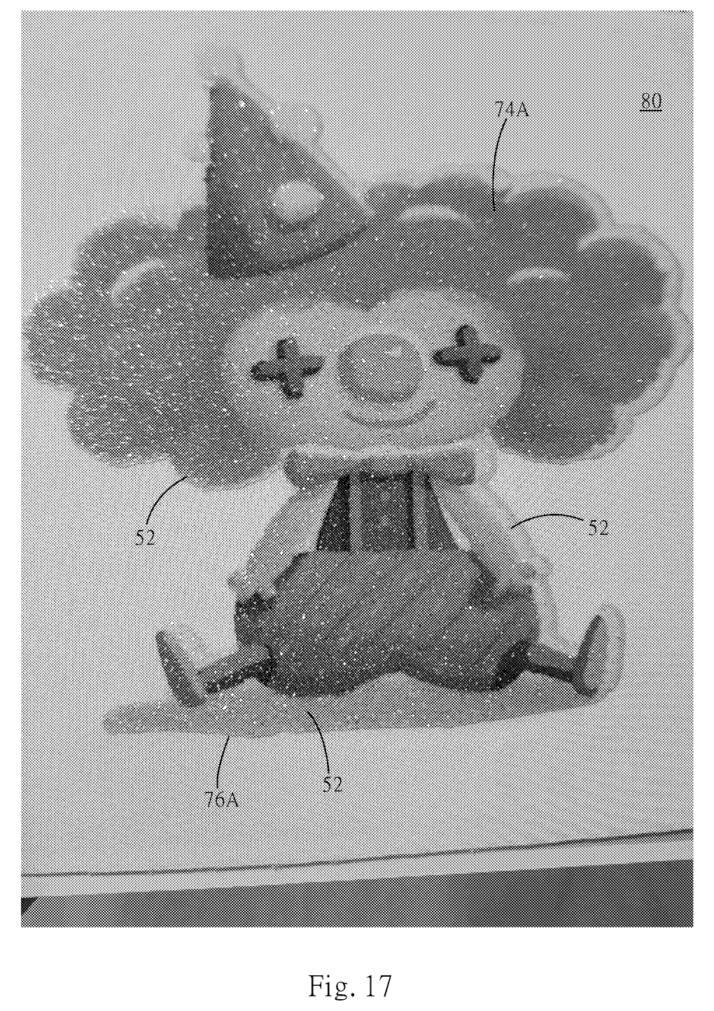

Please refer to FIG. 15, the graphic 76 is placed on a fabric 80 using the transfer film 79, with the adhesive layer (hot melt adhesive layer) 30 of the graphic 76 in contact with the fabric 80. The graphic 76 is then heat-pressed, for example, at 145°C for 30 seconds, using a same method as in FIG. 7. After heat pressing, the transfer film 79 is removed. The graphic 76 (including the pattern 74) is adhered to the fabric 80 by an adhesive formed by the adhesive layer 30. FIG. 16 shows a finished product of the graphic 76 heat-pressed onto the fabric 80. The thermal-sublimation pattern 74 is covered with the glitter powders 52, creating the glitter pattern 74 with a shimmering effect.

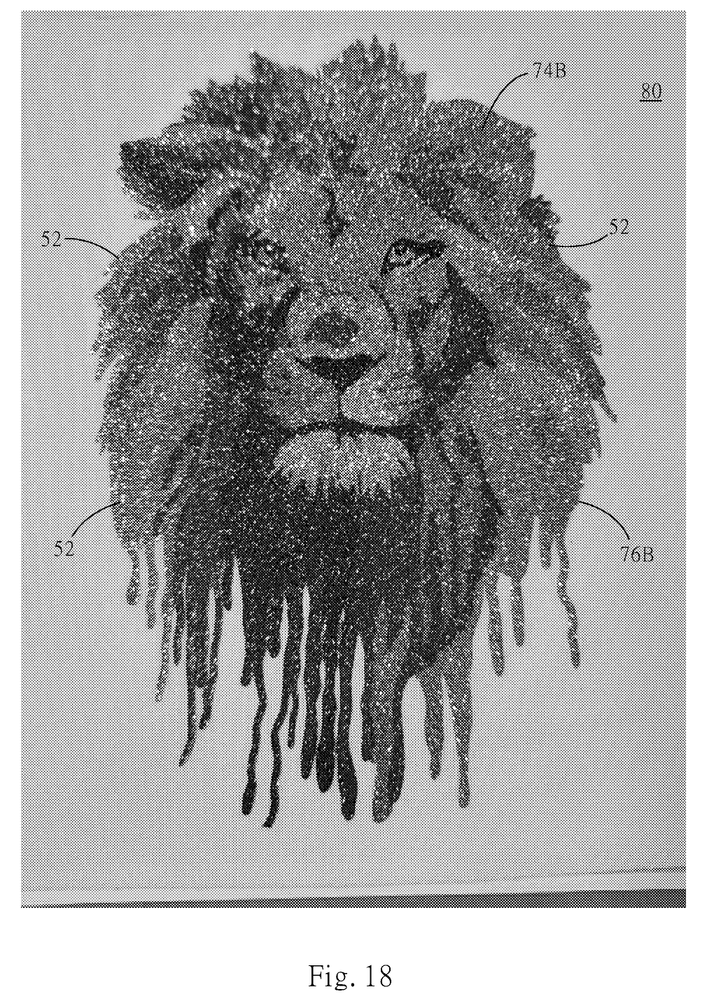

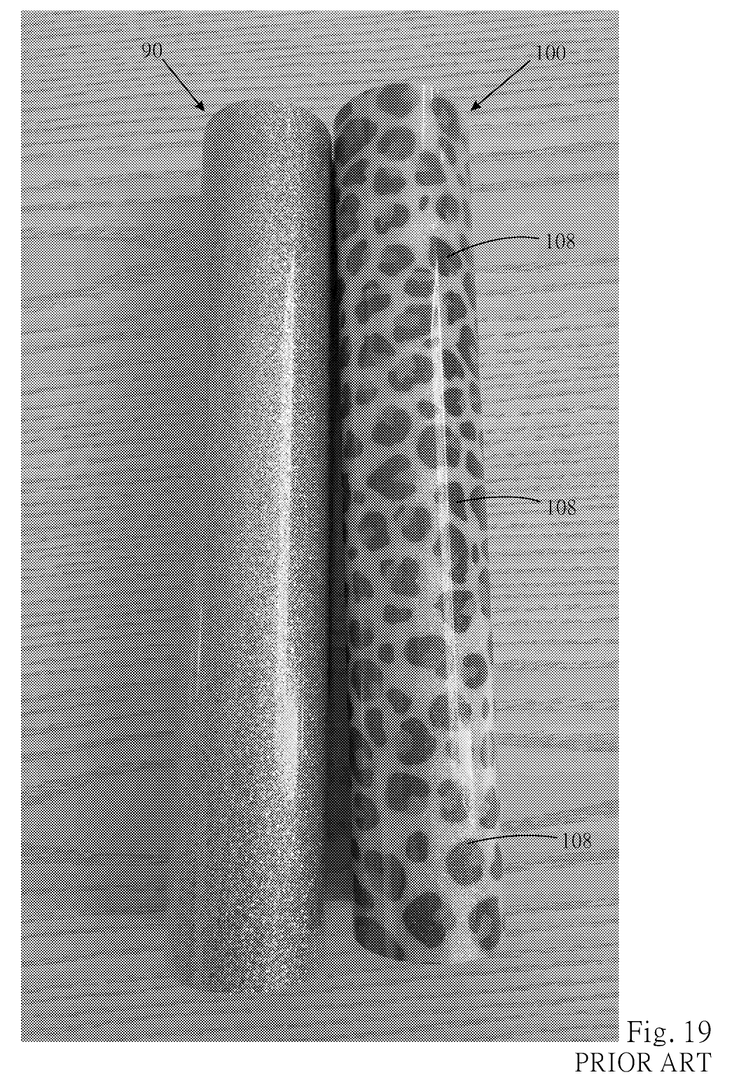

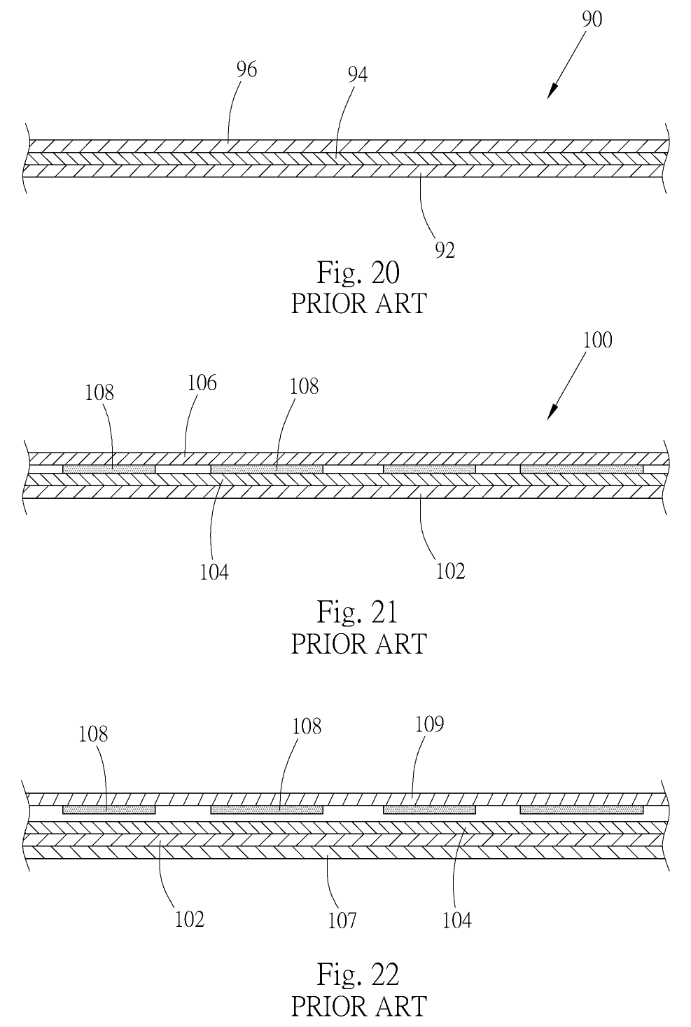

FIGS. 17 and 18 show two graphics 76A, 76B heat-pressed and adhered onto the fabric 80. The two graphics 76A, 76B present the thermal-sublimation pattern 74A and a thermal-sublimation pattern 74B, which are densely covered with the glitter powders 52, creating a shimmering effect.

The glitter film material 10 provided by the invention is capable of solving deficiencies of the prior art. Regarding the glitter powders 52, 52A, the aluminum inner layer 55 and the zinc sulfide inner layer 56 are encapsulated within the glitter powders 52, 52A. The surface 57 of each of the glitter powders 52, 52A is made of polyester material, without any other material. Similarly, the surfaces 57 of the glitter powders 52B are also made of polyester material, without any other components. Therefore, when the thermal-sublimation ink of the pattern 74 is thermal sublimated to the glitter layer 50, the thermal-sublimation ink bonds to the polyester surfaces 57 of the glitter powders 52, 52A, and does not bond to aluminum or zinc sulfide surfaces. Thus, a color of the thermal-sublimation ink is saturated and vivid, and the pattern 74 has a bright, vivid color and a glossy finish. Furthermore, due to a distinct color of the ink, the thermal-sublimation ink is suitable for printing the pattern 74 in multiple colors. The patterns 76, 76A, and 76B in FIGS. 16, 17, and 18 all have multiple colors, and the colors are vivid, with fine lines. Even though the thermal-sublimation ink is bonded to the cut surfaces 58 of the glitter powders 52, 52A, most of the areas of the cut surfaces 58 are still polyester, and aluminum or zinc sulfide only occupies small areas. Therefore, the thermal-sublimation ink still has a saturated and vivid color.

The glitter film material 10 of the invention enables consumers and businesses to easily create various thermal-sublimation patterns 74 on the glitter film material 10 and adhere the glitter thermal-sublimation patterns 74 to a fabric, as shown in a manufacturing process in FIG. 5 to FIG. 16. A peel force between the adhesive layer 30 and the base layer 20 is between 20 grams and 80 grams per square centimeter, making it easy to separate. In a heat pressing process shown in FIG. 7, when the thermal-sublimation ink of the thermal-sublimation paper 72 is thermally-sublimated onto the glitter layer 50 of the glitter film material 10, the hot melt adhesive layer 30 generates viscosity when heated. Because a peel force between the hot melt adhesive layer 30 and the base layer 20 is low, the hot melt adhesive layer 30 can be easily separated from the base layer 20. Therefore, when removing the waste material W as shown in FIG. 12, a user can easily tear off and remove the waste material W, and easily remove fine waste material in the pattern 74, such as a small triangular waste material in the letter A. A design of the hot melt adhesive layer 30, which is easily separable from the base layer 20, facilitates removal of fine and complex waste materials. Because the base layer 20 is easily separable from the hot melt adhesive layer 30, the base layer 20 can be easily and smoothly peeled off without damaging the thermal-sublimation pattern 74 and the glitter film material 10.

In the invention, because the layered heat-resistant component 40 is disposed under the glitter layer 50, an adhesive of the adhesive layer 30 can be prevented from spreading upward to the glitter layer 50. Therefore, during a thermal-sublimation process of the pattern 74 in FIG. 7, the thermal-sublimation paper 72 will not stick to the adhesive layer 30. In FIG. 15, when the graphic 76 is heat-bonded to the fabric 80, the high-temperature barrier layer 42 and/or the layer of adhesive 44 are/is capable of blocking an adhesive of the adhesive layer 30, preventing the adhesive from spreading upward to the glitter layer 50 and the ink of the pattern 74, making it easy for the glitter film material 10 to separate from the thermal-sublimation paper 72.

When the glitter layer 50 of the glitter film material 10 uses the glitter powders 52 shown in FIG. 2A, the thermal-sublimation graphic 76 can have various colors of glitter luster depending on a color of the inner layer 55. When the glitter layer 50 of the glitter film material 10 uses the transparent iridescent glitter powders 52A shown in FIG. 2B, a refracted light of the glitter powders 52A is an iridescent light, providing the thermal-sublimation graphic 76 an iridescent (multicolored) light effect. When the glitter layer 50 of the glitter film material 10 uses the transparent glitter powders 52B shown in FIG. 2C, the glitter powders 52B still have a shimmering effect, and the glitter layer 50 can be formed by mixing a small amount of silver glitter powders with the transparent glitter powders 52B, with a silver light assisting a shimmering effect. Preferably, a proportion of the silver glitter powders is less than a proportion of the transparent glitter powders. The glitter layer 50 can be formed by mixing the iridescent glitter powders 52A and the transparent glitter powders 52B. The glitter layer 50 can be formed by mixing colored glitter powders and the transparent glitter powders 52B. Preferably, a proportion of the colored glitter powders is less than a proportion of the transparent glitter powders.

The glitter film material 10 of the invention enables individuals or businesses to create the thermal-sublimation graphics 76 preferred by themselves. For manufacturers of glitter film materials, the invention is capable of reducing an amount of materials required for heat-pressing glitter graphics. Manufacturers only need to produce a small number of styles of the glitter film material 10 of the invention, such as the glitter film material 10 with the silver/transparent/iridescent glitter powders, without the need to produce the conventional glitter plotter-cut films 90, 100. Therefore, the invention is capable of significantly reducing a number of styles to be produced, and also capable of reducing display space and storage space for goods sold in stores, reducing manufacturing and inventory costs, meeting environmental protection requirements.

Although the invention has been disclosed as above with the embodiments, they are not intended to limit the invention. A person having ordinary skill in the art to which the invention pertains can make various changes and modifications without departing from the spirit and scope of the invention. Therefore, a scope of protection of the invention shall be subject to what is defined in the pending claims.

What is claimed is:

1. A thermally-sublimable glitter film material comprising:
a base layer with release properties;
an adhesive layer disposed on the base layer;
a layered heat-resistant component capable of withstanding temperatures higher than those at which the adhesive layer generating viscosity when heated, the layered heat-resistant component being disposed on the adhesive layer; and
a glitter layer comprising glitter powders, disposed on the heat-resistant component, forming an outermost surface of the glitter film material, each of the glitter powders having a pair of outer surfaces positioned on opposite sides, the two outer surfaces of each of the glitter powders being entirely made of polyester material.

2. The glitter film material as claimed in claim 1, wherein each of the glitter powders is a sandwich structure having two outer layers and at least one inner layer, and the two outer layers are made of polyester material.

3. The glitter film material as claimed in claim 1, wherein the glitter powders are silver glitter powders or iridescent glitter powders.

4. The glitter film material as claimed in claim 2, wherein the glitter powders are colored glitter powders or iridescent glitter powders.

5. The glitter film material as claimed in claim 2, wherein the inner layer has a metallic material, or has a material capable of producing an iridescent light.

6. The glitter film material as claimed in claim 1, wherein the glitter layer comprises at least two of the transparent glitter powders, colored glitter powders and iridescent glitter powders.

7. The glitter film material as claimed in claim 6, wherein the colored glitter powders comprise silver glitter powders.

8. The glitter film material as claimed in claim 6, wherein the glitter powders of the glitter layer comprise the transparent glitter powders, a proportion of other glitter powders is less than a proportion of the transparent glitter powders.

9. The glitter film material as claimed in claim 1, wherein a peel force between the adhesive layer and the base layer is between 20 grams and 150 grams per inch of width.

10. The glitter film material as claimed in claim 1, wherein the adhesive layer is made of hot melt adhesive, after the adhesive layer generates viscosity when heated, a peel force between the adhesive layer and the base layer is between 20 grams and 150 grams per inch of width.

11. The glitter film material as claimed in claim 1, wherein the layered heat-resistant component is a high-temperature barrier layer capable of withstanding temperatures above 170°C.

12. The glitter film material as claimed in claim 11, wherein the high-temperature barrier layer is made of high-temperature resistant thermoplastic polyurethane or polyurethane.

13. The glitter film material as claimed in claim 1, wherein the layered heat-resistant component is a layer of adhesive, the layer of adhesive is capable of withstanding temperatures above 170°C.

14. The glitter film material as claimed in claim 1, wherein the layered heat-resistant component comprises a high-temperature barrier layer and a second layer, the high-temperature barrier layer is disposed on the adhesive layer, the second layer is disposed on the high-temperature barrier layer; the glitter layer is disposed on the second layer.

15. The glitter film material as claimed in claim 14, wherein the high-temperature barrier layer is a high-temperature resistant thermoplastic polyurethane layer, the second layer is a polyurethane layer.

16. The glitter film material as claimed in claim 1, wherein the adhesive layer is made of hot melt adhesive or pressure-sensitive adhesive.

17. The glitter film material as claimed in claim 16, wherein the hot melt adhesive is an ethylene-vinyl acetate (EVA) hot melt adhesive, a polyethersulfone (PES) hot melt adhesive or a thermoplastic polyurethane (TPU) hot melt adhesive.

18. The glitter film material as claimed in claim 1, wherein a thermal-sublimation ink is thermally sublimated to the glitter layer of the glitter film material, the thermal-sublimation ink bonds with the glitter powders of the glitter layer.
